(19) United States
(12) Patent Application Publication
(10) Pub. No.: US 2022/0058738 A1
(43) Pub. Date: Feb. 24, 2022

(54) SYSTEM AND METHOD FOR DYNAMIC ASSET PORTFOLIO ALLOCATION AND MANAGEMENT

(71) Applicant: AllocateRite, LLC, New York, NY (US)

(72) Inventors: John Rebuth, New York, NY (US); Michael Spece, New York, NY (US); Abbas Shah, New York, NY (US)

(21) Appl. No.: 17/405,072

(22) Filed: Aug. 18, 2021

Related U.S. Application Data
(60) Provisional application No. 63/067,508, filed on Aug. 19, 2020.

(51) Int. Cl. G06Q 40/06

(52) U.S. Cl. CPC G06Q 40/06; G06N 20/00

(57) ABSTRACT

A dynamic asset portfolio allocation and management platform is disclosed. An example embodiment is configured to: receive information from a user, the information being indicative of the user's objectives or selections related to the user's asset portfolio; receive the user's asset portfolio; use a trained machine learning model to analyze and automatically rebalance the user's asset portfolio based on the user's objectives or selections; and cause execution of trading activity based on the rebalanced user's asset portfolio.

### CROSS-REFERENCE TO RELATED APPLICATIONS

This application claims the benefit of the filling date of U.S. Provisional Application Ser. No. 63/067,508 titled “SYSTEM AND METHOD FOR DYNAMIC ASSET PORTFOLIO ALLOCATION AND MANAGEMENT” and filed Aug. 19, 2020, and the subject matter of which is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2019-2020, AllocateRite, LLC, All Rights Reserved.

### TECHNICAL FIELD

This patent document pertains generally to data processing, deep learning, machine learning and artificial intelligence (AI) systems, data communication networks, risk management, asset portfolio management, and more particularly, but not by way of limitation, to a system and method for intelligent machine learning optimization to operate on large volumes of dynamic content, such as dynamic asset portfolio allocation and management.

### BACKGROUND

Machine learning and artificial intelligence (AI) systems are becoming increasingly popular and useful for processing data and augmenting or automating human decision making in a variety of applications. For example, images and image analysis are increasingly being used for autonomous vehicle control and simulation, among many other uses. Statistical data and financial data are types of input that can be used to train an AI system to identify patterns and trends. However, AI systems have been inadequately used in the conventional technologies for effectively managing asset portfolios and assessing risk. As a result, conventional systems have been unable to harness the power of AI to efficiently manage investments. As the investment opportunity landscape continually changes, there is a greater need for new dynamic approaches that leverage innovations in asset portfolio design and risk management for small investors and for the larger institutions and hedge funds.

### BRIEF DESCRIPTION OF THE DRAWINGS

The various embodiments are illustrated by way of example, and not by way of limitation, in the figures of the accompanying drawings in which:

FIG. 1 illustrates an example embodiment of the dynamic asset portfolio allocation and management methodology as described herein for performing dynamic asset portfolio allocation and management according to a process flow overview example;

FIG. 2 illustrates a portfolio customization synthesis and calibration workflow in an example embodiment of the dynamic asset portfolio allocation and management platform;

FIG. 3 illustrates an alternative example embodiment of the dynamic asset portfolio allocation and management methodology as described herein for performing dynamic asset portfolio allocation and management according to an alternative process flow overview example;

FIG. 4 illustrates a trading process workflow in an example embodiment of the dynamic asset portfolio allocation and management platform; and

FIG. 5 is a process flow diagram illustrating an example embodiment of a system and method for implementing a dynamic asset portfolio allocation and management workflow.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

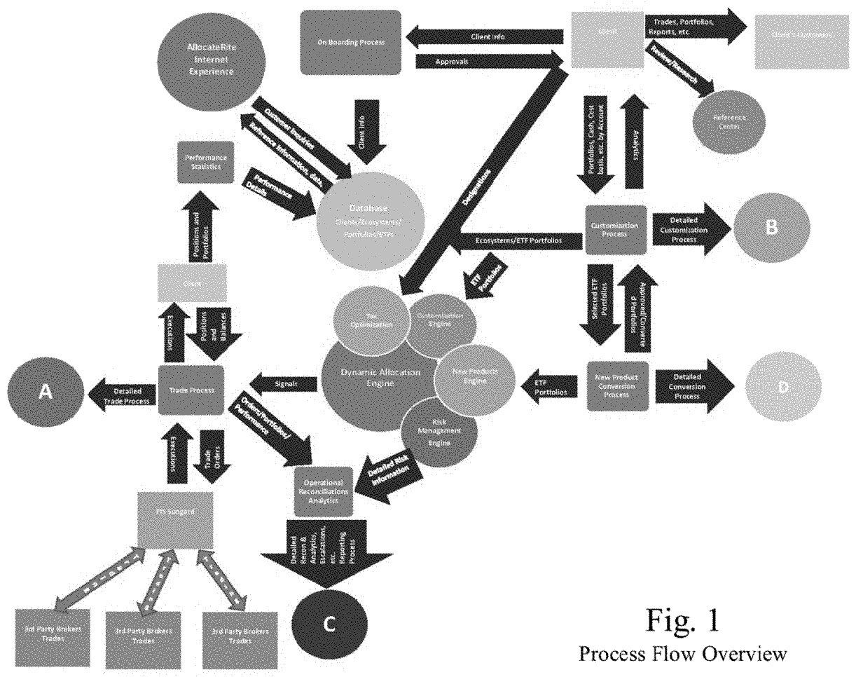

A dynamic asset portfolio allocation and management platform is disclosed. In the various example embodiments disclosed herein, a dynamic asset portfolio allocation and management system can be implemented to automate an investment strategy that is designed to realize optimized returns over longer term time horizons. This is accomplished by utilizing a new risk based approach to investing. Through dynamic diversification combined with real time rebalancing across different sectors and asset classes, users of the dynamic asset portfolio allocation and management system can over time achieve higher returns than most other broad market benchmarks. An important feature of the disclosed embodiments is to avoid market disruptions and offset and hedge risk, where possible. The dynamic asset portfolio allocation and management system provides the average retail investor a highly sophisticated Asset Allocation Model presented in a simple manner The Asset Allocation Model evaluates fundamental and technical information and then runs this information through various workflows, processes, and statistical techniques as disclosed herein. A primary goal is to identify the low risk sectors while balancing overall exposures across equities, fixed income, and cash. Consequently, the asset portfolio attributes include diversification, high liquidity, low overall costs, and potential tax advantages. FIG. 1 illustrates an example embodiment of the dynamic asset portfolio allocation and management methodology as described herein for performing dynamic asset portfolio allocation and management according to a process flow overview example.

Referring to FIG. 1, the dynamic asset portfolio allocation and management platform of an example embodiment provides intelligent portfolio asset allocation and management processes that deliver a better risk/reward profile than what users may have obtained on their own or currently have. The dynamic asset portfolio allocation and management platform of an example embodiment can be used for any collection of securities or asset portfolios. In general, the dynamic asset portfolio allocation and management platform receives a collection of securities or asset portfolios and optimizes the collection of securities or asset portfolios based on objectives explicitly and implicitly defined by a user. The dynamic asset portfolio allocation and management platform of an example embodiment provides a Dynamic Allocation Engine that uses trained machine learning models to automatically review and re-allocate an asset collection proposed by a user to better meet the user's objectives. The Dynamic Allocation Engine can be configured to serve a variety of applications including finance, tax, risk management, and the like.

As shown in FIG. 1, the Dynamic Allocation Engine can receive input from a variety of sources in a particular ecosystem. These inputs can be received via an application programming interface (API) among other ways of automated data exchange. The Dynamic Allocation Engine can be configured to use artificial intelligence to process these inputs for a specific purpose (e.g., tax optimization using a tax optimization engine, customization using a customization engine, new product design using a new products engine, risk management using a risk management engine, or a variety of other applications).

The dynamic asset portfolio allocation and management platform of an example embodiment provides a Portfolio and Risk Dashboard to enable client interaction with the system and enable the client to provide information indicative of the client's objectives. The dynamic asset portfolio allocation and management platform of an example embodiment is configured to use artificial intelligence (e.g., a trained machine learning model or deep learning neural networks) to accept client input and produce compliant and optimized output based on client objectives and real-time ecosystem data. The platform can use artificial intelligence, for example, to perform asset portfolio construction and optimization both as an input and an output mechanism (e.g., unique for input and output of information from portfolios and other information). The platform is configured to automatically rebalance a portfolio based on a user's requirements or objectives for generating a portfolio alpha, where alpha represents the performance of a portfolio relative to a benchmark. The portfolio alpha is often considered to represent the value that a portfolio manager adds to or subtracts from a fund's return. In other words, alpha is the return on an investment that is not a result of general movement in the greater market.

The dynamic asset portfolio allocation and management platform of an example embodiment can be integrated with a user interface dashboard, which can provide ease of use and visual/audio output. The platform can also provide a transaction system, such as an Order Management System (OMS) that can issue orders (e.g., stock trade orders) related to an order for a particular identified item, in a particular quantity, and from a particular source. The platform can also be configured to receive and analyze data related to the analytical performance of assets (e.g., portfolio assets, securities, or other instruments) and data related to market risk levels (e.g., factor evaluation resulting in a determination of the probability of the occurrence of an event).

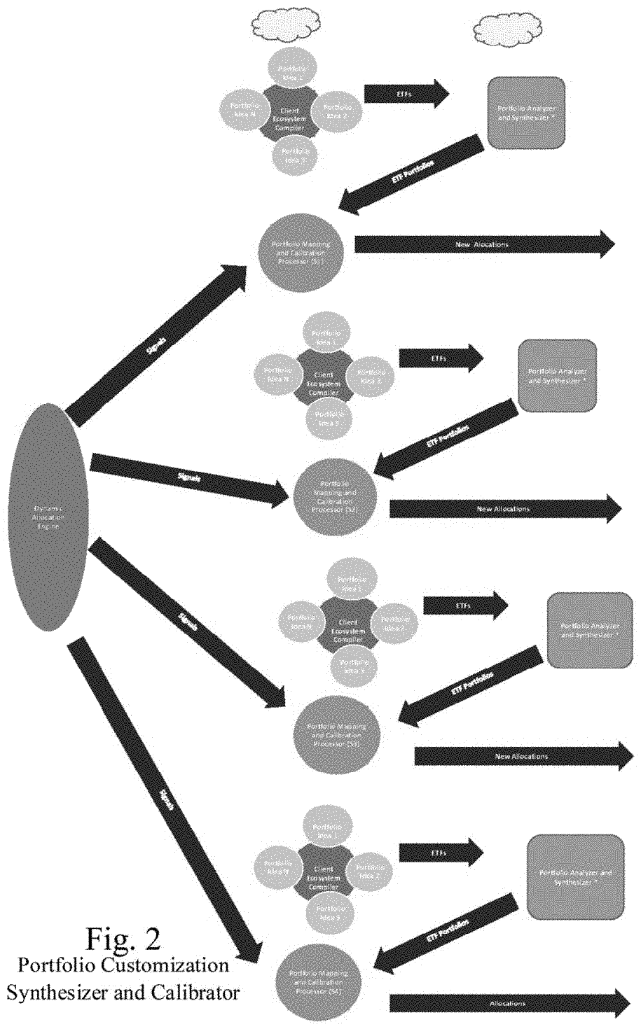

FIG. 2 illustrates a portfolio customization synthesis and calibration workflow in an example embodiment of the dynamic asset portfolio allocation and management platform. As shown in FIG. 2, the Dynamic Allocation Engine is configured to create the asset allocations and trade rebalancing signals leveraged by the individual portfolios. The Dynamic Allocation Engine is configured to use trained machine learning models to perform asset portfolio optimization and customization. Tax optimization is example of user customization.

The Dynamic Allocation Engine of an example embodiment is configured to use, for example, a tax overlay with AI predictive analytics to optimize individual asset portfolios based on tax requirements and as instructed by the user. The Dynamic Allocation Engine can also concurrently deliver rebalancing trades across a plurality of individualized and tailored portfolios through a centrally-based risk overlay. The dashboard tool can interface with the Dynamic Allocation Engine with synchronized operational infrastructure to deliver portfolio construction and optimization, risk management, trade execution, client management, trade execution and OMS, tax optimization over-laid with predictive deep learning portfolio optimizers, reporting and risk analytics, research, operational oversight, and reconciliation tools.

In a particular example embodiment, the dynamic asset portfolio allocation and management platform provides among the following features and benefits:
Provides a Portfolio Customization Synthesizer and Calibrator for dynamic asset portfolio allocation and management.
Provides an Ecosystem Compiler, which is a web-based tool for users to automatically generate individual portfolios of ETFs across asset classes.
Provides a web-based tool enabling users to have easy access to the current universe of ETFs available for selection within a portfolio.
Allows the user to select any combination of the currently available ETFs by category, or request a new set of ETFs for composition within a portfolio. The user can automatically submit this information upon completion of the newly-configured or proposed portfolio.
Provides a Portfolio Analyzer and Synthesizer that automatically reviews the newly-configured or proposed portfolio through its model to ensure compatibility and effectiveness of the newly-configured or proposed portfolio. This information is then passed through to the Portfolio Mapping and Calibration Processor for proper weighting and balancing of ETFs within the proposed portfolio. Newly approved portfolios can then be retained within the individual user's ecosystem of portfolios and made available to be used in future reallocations. Rejected portfolios can be returned to the user with criteria for rejection.

Referring again to FIG. 2, a Portfolio Mapping and Calibration Processor is configured as a fully automated and integrated process. The Portfolio Mapping and Calibration Processor allows financial institutions/partners (“FIPs”) to choose their own ecosystem of ETFs and portfolios. The ETF ecosystems are tested and vetted by a host of the dynamic asset portfolio allocation and management platform to ensure their compatibility and effectiveness. All portfolios held in the FIP ecosystem will be approved and clearly designated to specifically segregated customer positions and balances.

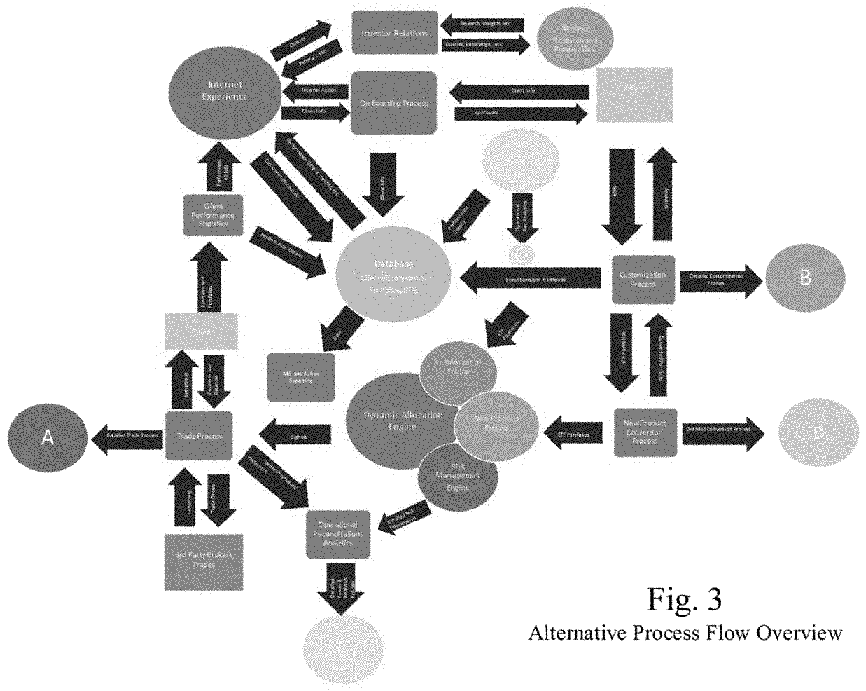

FIG. 3 illustrates an alternative example embodiment of the dynamic asset portfolio allocation and management methodology as described herein for performing dynamic asset portfolio allocation and management according to an alternative process flow overview example.

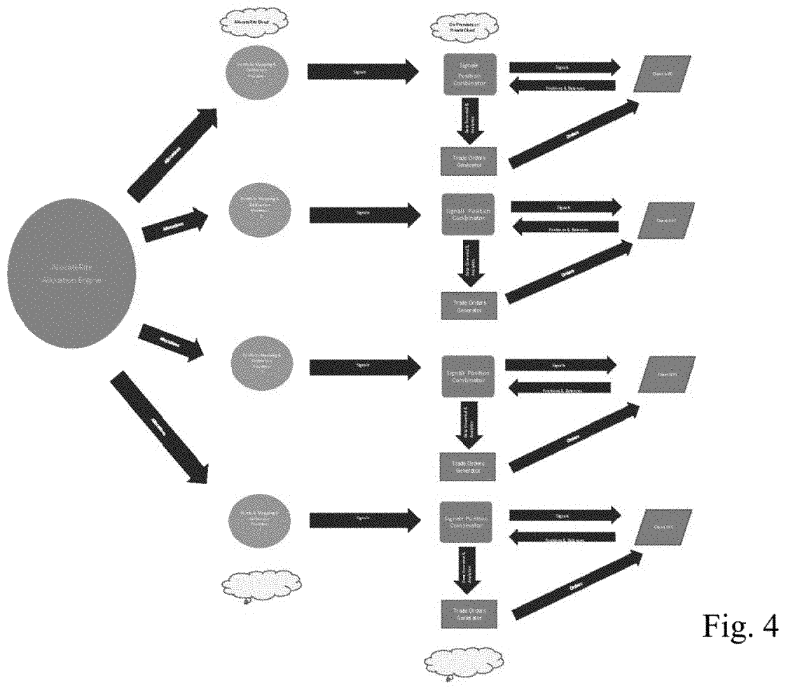

Referring to FIG. 4, the host of the dynamic asset portfolio allocation and management platform can provide a Customized Trade Order Processor/Generator, which can be configured to perform a variety of functions. An HP sending positions and balances file (detailed by customer account number) with the designated account positions and balances (held within separate client accounts) can be maintained. The host can receive (into a secure FTP site) this client information on a daily basis. Then, when a reallocation signal file is generated, the host platform can upload the most current position and balance file and calculate the new asset allocation and delta by ETF/security. This information is then aggregated to generate the corresponding trade orders. Alternatively, or in combination, the platform host can send a reallocation signal file with the new portfolio allocation percentages by ETF/security to the respective FIP secure FTP sites. All allocations are sent out concurrently to all locations designated by the FIPS.

The dynamic asset portfolio allocation and management platform of an example embodiment provides a Portfolio Customization feature, which allows clients to create their own ecosystem of ETFs across the various asset classes (e.g., equities, fixed income, and cash). The platform host can have a universe of ETFs that have been tested and are available for selection within host system. The FIP can select any combination of ETFs, and the host can automatically run the selected combination through the model. The host can review the output and generate a properly balanced portfolio. The client can review and confirm accordingly. In addition, the FIP can request the host to include a completely new set of ETFs for inclusion within the model. The Portfolio Mapping and Calibration Processor can then produce the constituents and recommend a weighted portfolio to the FIP. If the requested ETF combination is not able to meet the model requirements for any reason, the host may agree with the FIP to build-out separate module/functionality within the Dynamic Allocation Engine.

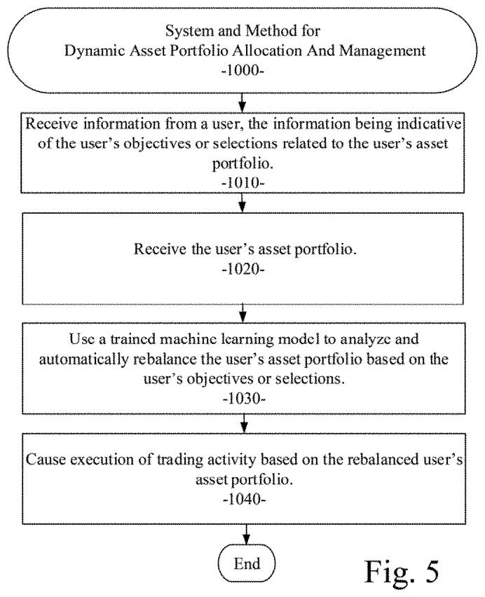

Referring now to FIG. 5, a flow diagram illustrates an example embodiment of a system and method 1000 for dynamic asset portfolio allocation and management. The example embodiment can be configured to: receive information from a user, the information being indicative of the user's objectives or selections related to the user's asset portfolio (processing block 1010); receive the user's asset portfolio (processing block 1020); use a trained machine learning model to analyze and automatically rebalance the user's asset portfolio based on the user's objectives or selections (processing block 1030); and cause execution of trading activity based on the rebalanced user's asset portfolio (processing block 1040).

Glossary of Terms

| Term | Definition |
|---|---|
| Artificial Intelligence | Is conventionally, if loosely, defined as intelligence exhibited by |
| (AI) | machines. |
| Allocation | AllocateRite's terminology used to incorporate the generation of |
| | proposed buy-sell signals/trades of individual securities by its |
| | dynamic algorithmic model to properly rebalance portfolios |
| Broker | Financial Institutions that buys and sells securities (executing |
| | broker) and/or holds custody of financial assets (custodian |
| | broker). |
| Composite | An aggregation of one or more portfolios managed according to |
| | a similar investment mandate, objective, or strategy and is the |
| | primary vehicle for presenting performance to prospective |
| | clients. |
| Current Value | The summation of quantity multiplied by price of all securities |
| | held within a portfolio on that same day. |
| Dynamic Asset | A portfolio management strategy that frequently adjusts the mix |
| Allocation | of asset classes to better manage risks in varying market |
| | conditions. |
| Equities | Common stocks (ordinary shares) traded in a securities market. |
| ETF | An exchange-traded fund (ETF) is a collection of securities you |
| | buy or sell through a brokerage firm on a stock exchange. ETFs |
| | are offered on virtually all asset classes ranging from traditional |
| | investments to alternative assets. |
| Financial Crisis | The crisis risk is essentially a max downside risk over a window |
| | of time that goes back to either the (i) Financial Crisis or (ii) |
| | earliest IPO among a portfolio's tickers, whichever is most recent |
| Fixed Income | Type of debt instrument that provides returns in the form of |
| | regular, or fixed, interest payments and repayments of the |
| | principal when the security reaches maturity. Instruments are |
| | issued by governments, corporations, and other entities to |
| | finance their operations |
| Global Macro Model | Based on global technical and/or fundamental analysis to |
| | directionally position a portfolio across a broad range of markets |
| | and/or asset classes. Fundamental factors evaluate opportunities |
| | based on criteria such as valuation metrics, economic forecasts, |
| | interest rate and currency outlooks, and fiscal and monetary |
| | policy. The information employed may be macro-economic or |
| | the aggregation of micro-level information. These managers tend |
| | to be close followers of academia, particularly econometrics. • |
| | Technical factors utilize predictive signals that are generated |
| | from market-related information (e.g., price, volume), and often |
| | involve the use of pattern recognition and other types of |
| | advanced statistical forecasting tools |
| Inception Date | Starting date of when capital was invested for a specific account |
| ITD | Inception to Date |
| Initial Capital | The starting investment monies contributed to a specific account |
| Liquidity | A high volume of activity in a financial marketplace/exchange |
| Long Only | Term used to identify portfolios that buy “long” positions in |
| | assets and securities. To be “long” an asset, derivative or security |
| | means being a buyer, generally one who benefits from an |
| | increase in prices |
| LTD | Life to Date |
| MTD | Month to Date |
| Re-balance | AllocateRite's terminology used to incorporate the generation of |
| | proposed buy-sell signals/trades/allocation percentages of |
| | individual securities for a portfolio or set of portfolios by its |
| | dynamic algorithmic model |
| Return/Performance | The quantification of total gains and losses over the account's |
| | equity for a designated time frame |
| Strategy | AllocateRite's terminology used to identify a subset within one |
| | of AllocateRite's Composites based on a set of characteristics |
| | that would constitute distinct portfolio group |
| YTD | Year to Date |
| Value | Shorthand for Market Value |
| AI Based Overall | A composite risk score based on the geometric average of the |
| Portfolio Risk Forecast | expected and crisis risks |
| Maximum Potential | Is the maximum potential loss of value a current portfolio could |
| Loss | incur under extreme conditions as calculated by AR AI risk |
| | forecaster |
| Drawdown (Potential | The maximum loss in the portfolio's value from peak to trough. |
| Loss) | This is an indicator of risk in a specific portfolio |
| Expected Risk | Also known as Expected Shortfall (ES) or Conditional Value at |
| | Risk (CVaR) is a statistic used to quantify the risk of a portfolio. |
| | Given a certain confidence level, this measure represents the |
| | expected loss when it is greater than the value of the VaR |
| | calculated with that confidence level. The Conditional Value-at- |
| | Risk (CVaR) is closely linked to VaR. It is simply the average of |
| | those values that fall beyond the expected VaR. This translates to |
| | the further potential of loss of an asset or portfolio. Riskier assets |
| | will exceed VaR by a more significant degree |
| Liquidity Risk | Risk that the organizing company or bank may be unable to meet |
| | short term financial demands. This usually occurs due to the |
| | inability to convert a security or hard asset to cash without a loss |
| | of capital and/or income in the process |
| Maximum Downside | Traditionally known as drawdown, the downside risk historically |
| Risk | measures the loss between portfolio highs and lows. The |
| | maximum of these measurements (over a given window of time) |
| | represents the risk from mistiming the market. In the |
| | RiskMonkey max downside risk plot, this window is |
| | approximately 2.5 years |
| Maximum Historical | The max loss suffered by the portfolio since 2007 with |
| Drawdown | historically monthly dynamic portfolio rebalancing. The |
| | portfolio was rebalanced monthly |
| Correlation with S&P | A number from 0 to 1 that reveals how closely a portfolio tracks |
| Forecast | the benchmark (S&P) |
| Risk | AllocateRite's calculation of potential risk of loss in a portfolio |
| | based on sophisticated dynamic computations using proprietary |
| | statistical and AI based modeling tools. AllocateRite calculates |
| | its own VaR and CVaR using this methodology |
| VaR | A measurement and quantification of the potential level of |
| | financial downside risk within a portfolio or position over a |
| | specific time frame. It is the possible loss in value assuming |
| | “normal market risk” as opposed to all risks. More specifically, it |
| | is the statistical probability of the loss, using a confidence |
| | interval, defining the probability distributions of individual risks, |
| | the correlation across these risks and the effect of such risks on |
| | the portfolio's value. For example, if an investor's 10-day 99% |
| | VAR is $10,000.00, there is considered to be only a 1% chance |
| | that losses will exceed S10,000.00 in 10 days |
| Correlation | Statistical measure of the degree to which the movements of two |
| | variables are related |
| Dispersion | A term used in statistics that refers to the location of a set of |
| | values relative to a mean or average level. In finance, dispersion |
| | is used to measure the volatility of different types of investment |
| | strategies. Returns that have wide dispersions are generally seen |
| | as more risky because they have a higher probability of closing |
| | dramatically lower than the mean. In practice, standard deviation |
| | is the tool that is generally used to measure the dispersion of |
| | returns |
| Fundamental Inputs | Use valuation techniques and macroeconomic variables as inputs |
| (basis for investment | to investment decisions |
| views) | |
| Overbought | An indicator that a given security's price has become abnormally |
| | high and, thereby, potentially expensive |
| Oversold | An indicator that a given security's price has become abnormally |
| | low and, thereby, potentially cheap |
| Momentum (MOM) | Indicates whether a given security's price has an upward (icon), |
| | downward (icon), or neutral (icon) trend, based on the recently |
| | observed acceleration of the stock's return. It is upward if the |
| | security has positive acceleration but is not overbought; |
| | downward if the given security has negative acceleration but is |
| | not oversold; and neutral otherwise. Note these trends only factor |
| | in price movements, not necessarily fundamental changes in |
| | either the market or the underlying assets of the security; such |
| | trends are said to be purely technical. As historical measures, |
| | they are subject to reversal at any time and are not |
| | recommendations |
| Stacking/Layering | An algorithm that takes the outputs of sub-models as input and |
| | attempts to learn how to best combine the input predictions to |
| | make a better output prediction. |
| Systematic Style | No human intervention in trade generation |
| (application of views) | |
| Technical Inputs (basis | Employ market-based (e.g., price and volume) information as |
| for investment views) | inputs to trading decisions |
| Volatility or VIX | A statistical measure of the tendency of a market or security to |
| | rise or fall sharply within a period of time - usually measured by |
| | standard deviation |

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A dynamic asset portfolio allocation and management system, the system comprising:
a data processor; and
a dynamic asset portfolio allocation and management module, executable by the data processor, the dynamic asset portfolio allocation and management module being configured to:
receive information from a user, the information being indicative of the user's objectives or selections related to the user's asset portfolio;
receive the user's asset portfolio;
use a trained machine learning model to analyze and automatically rebalance the user's asset portfolio based on the user's objectives or selections; and
cause execution of trading activity based on the rebalanced user's asset portfolio.
